(19) United States
(12) Patent Application Publication
(10) Pub. No.: US 2025/0014429 A1
(43) Pub. Date: Jan. 9, 2025

(54) Smart Arcade Kiosk with Advertiser Promotions and Player Rewards

(71) Applicant: Milind S. Bharvirkar, Orlando, FL (US)

(72) Inventor: Milind S. Bharvirkar, Orlando, FL (US)

(21) Appl. No.: 18/219,673

(22) Filed: Jul. 8, 2023

(51) Int. Cl. G07F 17/32; G07F 17/40

(52) U.S. Cl. CPC G07F 17/3276; G07F 17/3255; G07F 17/40

(57) ABSTRACT

A smart arcade kiosk with advertiser promotions and player rewards is disclosed. The invention is comprised of an arcade machine, a mobile device application (app), a web portal, and a cloud network. Stakeholders include consumers (e.g., gamers); sponsors (e.g., brand promoters); operators (e.g., kiosk owners); and system manager (e.g., Replay Esports). Gamers select either pay-to-play or free-to-play sponsored tournaments on the kiosk and compete for prizes that include real products, offers, or loyalty points. The advertiser uses an online portal to create tournaments across the connected kiosks. Operators, merchants, game developers, and the system manager receive a percentage of the revenue earned. An object of the invention is to provide a platform that allows retailers and other advertisers to enhance brand awareness among gamers, database their customers through fun games, reengage their consumers with new promotions, and accurately track returns on advertising investments.

### CROSS-REFERENCE TO RELATED APPLICATIONS

The present application includes subject matter disclosed in and claims priority to a provisional application entitled “Smart Arcade Kiosk with Advertiser Promotions and Player Rewards” filed Jan. 11, 2023 and assigned Application No. 63/438,375 describing an invention made by the present inventor.

### FIELD OF THE INVENTION

The present invention relates to gaming, more specifically to a system that networks arcade machines and holds tournaments to drive customers into retail establishments.

### BACKGROUND

An arcade video game can be an electronic, stand-alone, coin-operated system where player inputs from controllers or interfaces are processed through electronic or computerized components and displayed to a video device, typically a monitor, and are contained within an enclosed cabinet. Arcade video games are often installed alongside other arcade games such as pinball machines. Today, large arcades, such as Dave and Busters and Chuck E. Cheese, flourish because gamers enjoy the experience of playing for tickets and prizes. Many arcade games migrated to street locations such as restaurants, sports bars, movie theaters, amusement parks, and malls. Yet, these machines typically do not earn as well because the ticket and prize system are removed. Consequently, arcade machines in street locations have lost their luster with gamers and retailers. Many retailers and restaurants create free to play prize promotions, such as Monopoly at McDonalds, to drive more traffic and revenue for their business. Yet, these “gamification” promotions are too expensive to create and market for the small- to average-size retailer. By combining an arcade device with free-to-play gamification promotions, consumers enjoy playing for free and earning prizes and retailers benefit from low-cost promotions that drive more traffic and revenue.

### SUMMARY OF THE INVENTION

The device herein disclosed and described provides a solution to the shortcomings in the prior art through the disclosure of a smart arcade kiosk with advertiser promotions and player rewards. The kiosk has two modalities: pay to play and “free to play” sponsor promotions. The kiosk can accept cash, coin, credit card, or other forms of payment to play games like other traditional arcade games. Another object of the invention is to allow retailers to build brand awareness and repeat business among their consumers using a game kiosk. Retailers and other sponsors use a web portal or application to quickly create and deploy “free to play” game tournaments and promotions which they can distribute across kiosks of their choosing. During game play, sponsor advertisements can be displayed to gamers that allows them to enhance brand awareness.

Another object of the invention is the kiosks can promote one or many sponsored promotions or events at a time. Promotions can be a fun to play game, esports game tournament, collect to win promotion, sweepstake game promotion, scavenger hunt, trivia game, fantasy sports promotion, simulation game, or other types of games. The system issues a limited number of game credits daily so consumers play for their favorite prizes.

Another object of the invention is the networked kiosks are connected to a server with a central player account. Players can earn loyalty points redeemable for real prizes or digital goods on any kiosks in the network.

Another object of the invention is the system administrator, sponsor, or retailer can issue free game play credits or loyalty points to reward customers for buying products, watching videos, or participating in other marketing activities.

Another object of a smart arcade is the system administrator, sponsor, or retailer can deploy other applications on the device such as online stores, maps, coupon offers, video customer service, flight schedules, weather and time, sponsor information, and other applications relevant to a consumer, sponsor, or retailer.

Another object of the invention is to drive customer traffic to retail brick-and-mortar retailers by notifying customers of new promotions at the location using a mobile app (such as GO4), email, or text. For example, a clothing store creates and deploys a game promotion for a kiosk at its location. Those who score the highest on the game promotion receive a prize or loyalty points that can be redeemed as online vouchers or gift cards at the clothing store. The clothing store can create future game promotions to drive the same consumers back to the store.

Another object of the invention is to only charge advertisers or sponsors an ‘engagement fee’ when consumers play for their products. When consumers do play for products it demonstrates an interest in the brand. This model can be a pay per engagement model on the kiosk which is like a pay per click model on the internet. Free to play for consumers is a pay per engagement fee for the advertiser. The system can revenue share the pay per engagement fee amongst multiple stakeholders such as kiosk operator, retailer, game developer, and the system manager.

Another object of the invention is to provide a complete prize fulfillment service on arcade games for companies that do not have such a service. Advertisers can simply log into the web portal, choose a tournament, apply various rewards and activate said tournaments based on preset criteria such as a specific region or across kiosk location. Prizes vouchers and digital gift cards are stored in a mobile app wallet. Consumers are given instructions on how to redeem prizes at a retail location or online.

Another object of the invention is to cross promote advertisers or sponsors with other retailers. When sponsors develop promotions on the web platform, they can deploy their prize promotions into different types of retailers. For instance, an ice cream parlor can advertise a game promotion in a pizza restaurant, or an advertiser can promote its product in a big box retailer or mall.

Another object of the invention is to provide a means to advertise promotions or game tournaments to generate brand and sponsors consumer awareness among gamers. For example, a sponsor can create and deploy a digital advertisement to run on the attract mode of the kiosk. Consumers attracted to the sponsors prize can play for free to win sponsor's prize.

Another object of the invention is to provide remote monitoring of multiple kiosks for revenue, promotion results, and maintenance. The web portal or app allows sponsors, operators, game developers, and system administrator to connect and network to multiple arcade kiosks, monitor any tournament or prize promotion, and maintain any issues that arise during said tournaments.

Another object of the invention is to allow retailers to reward players with loyalty points and coupons or offers for participating in promotions. The rewards can be stored in a mobile wallet. The coupon can be redeemed on the kiosk or associated mobile application. If the player purchases the offer on the app or kiosk, the revenue is automatically sent to the retailer or sponsor. This method allows retailers and sponsors to measure the return on investment of their promotion. This strategy incentivizes all types of players to participate and frequent participating stores.

Another object of the invention is to collect data and perform trend analysis using artificial intelligence (AI). The app can collect player data over time and drives future promotions to players that meet the target demographic of the sponsor. This type of AI can inform vendors to make more lucrative choices when organizing events. For example, a sponsor can drive a promotion to players in a certain geographic area, select gender, an age range, and customer interest. A clothing store can drive a promotion to women, between the ages of 18-35, who live in Boise Idaho, play tennis, and like Gucci. An ice cream shop can drive a promotion to their customers within a 5-mile radius of their business on a slow day.

Another object of the invention is it targets players with promotional messages. After gamers participate in a tournament, the app can send gamers messages regarding tournament results and upcoming events.

Another object of the invention is to allow sponsors to understand their return on investments when advertising in kiosk games. When a player participates in a pay-for-play mode and receive offers and loyalty points on the app, the redemption process can be tracked by the app and can show sponsors all transactions that occur relating to their promotional activities-including all discounts and purchases made by the consumer.

Another object of the invention is to establish a platform creates a new relationship or ecosystem that includes new partners such as advertisers and other retailers. This ecosystem connects these stakeholders who can now participate in revenue sharing. Currently, arcade games do not revenue share with advertisers and retailers etc. (unlike slot machines that do allow for revenue sharing).

Upon reading this disclosure, those ordinarily skilled in the art will recognize various means for carrying out these intended features of the invention. As such, it is to be understood that other methods, applications, and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting. As such, those ordinarily skilled in the art will appreciate that the conception upon which this disclosure is based may readily be utilized as a basis for designing of other structures, methods, and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects feature, and advantages of the present invention, as well as the advantages thereof over existing prior art, which will become apparent from the description to follow, are accomplished by the improvements described in this specification and hereinafter described in the following detailed description which fully discloses the invention but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the invention.

FIG. 2 shows a representative view of the invention's method.

FIG. 3 shows an example of optional block chain features.

FIG. 4 shows the Go4Gold platform.

FIG. 5 shows an example of a tournament process.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

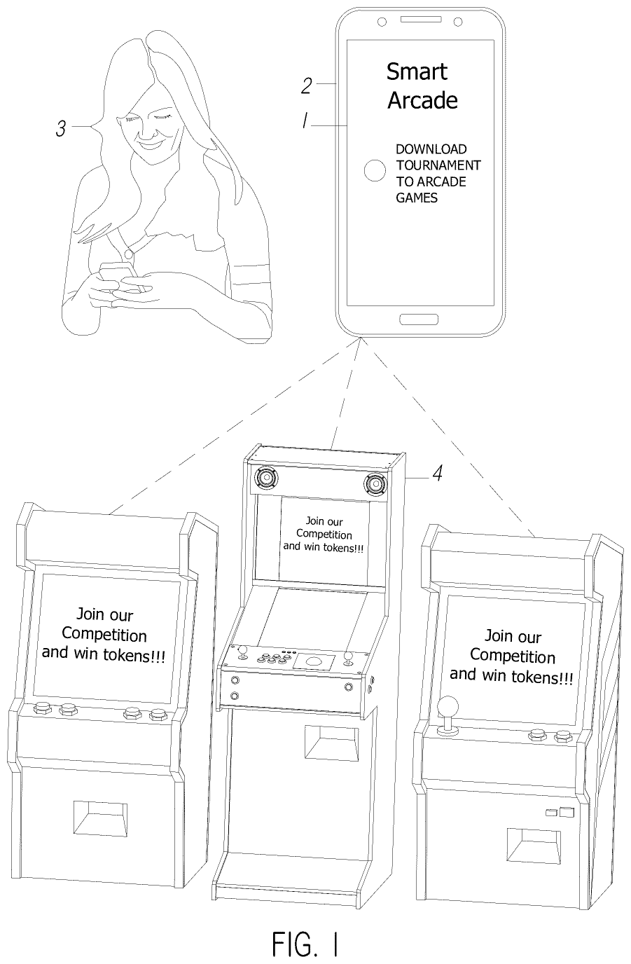

FIG. 1 shows a preferred embodiment of the invention comprised of a software app 1 operating system on a smartphone 2 being operated by user 3 and networking with a plurality of stand-alone, kiosk arcade games with cash and credit card swipe. Stakeholders include but are not limited to six parties: 1) Go4gold organization (who manages the app, website portal, revenue shares, receives payment for adverts and kiosk promotions referred to as engagements), 2) sponsors or advertisers (who pay Go4gold for players' free to play sessions only when an engagement is activated by a player, and pays for free to player); 3) merchants (who get revenue share from sponsors and player purchases and also pay an engagement fee); 4) players or gamers (those who pay to play or play the physical gaming machines); 5) operators (who are the brick-and-mortar kiosk property owners who get a revenue share from sponsors and player purchases) and retailers (who participate and honor rebates and discounts). The figure showing the Go4gold app wherein a player receives notifications, sponsors can generate custom promotions, sets prizes, stores winnings via digital wallet. A website portal is also included whereby sponsors create regional or single kiosk promotions and tournaments and upload promotions (with limited prizes). The sponsors can also have control over advertisements, leader boards, historical records, and can also set replays (life span of a promotion). The server that is connected to all kiosks and apps is managed by Go4gold management service (or Go4gold system administrator) on an existing commercial server. Currencies in the system can include but are not limited to: loyalty points, energy credits, tokens, and vouchers etc.

When gamers have an interaction with the kiosk they are presented with two options: a pay-to-play mode or a free-to-play mode. During pay-for-free mode tournaments players sync the app with the kiosk by signing in with a unique alpha numeric code or scanning a QR code and can receive energy credits, tokens, and reward points just for playing (local, regional or national high scoring players may get additional amounts of each). Merchant vouchers are similar in nature to traditional redemption tickets. During free-to-play sponsors are allowed to install their brand advertisement but are not allowed to post full promotion tournaments to kiosks and the sponsor pays Go4gold to allow player to use the kiosks. During pay-to-play mode, sponsors are allowed to generate promotional tournaments and players get energy credits just for playing and receive digital gift cards (loyalty points for rewards and prizes). During this mode they login and pick a prize promotion to participate in (also referred to as an engagement). During all gaming events, data is collected on the players along with return-on-investment data (how many winners went to merchants and what was purchased etc.). In some embodiments, sponsor survey questions can be displayed to the users and players can also earn loyalty points for participating in the surveys.

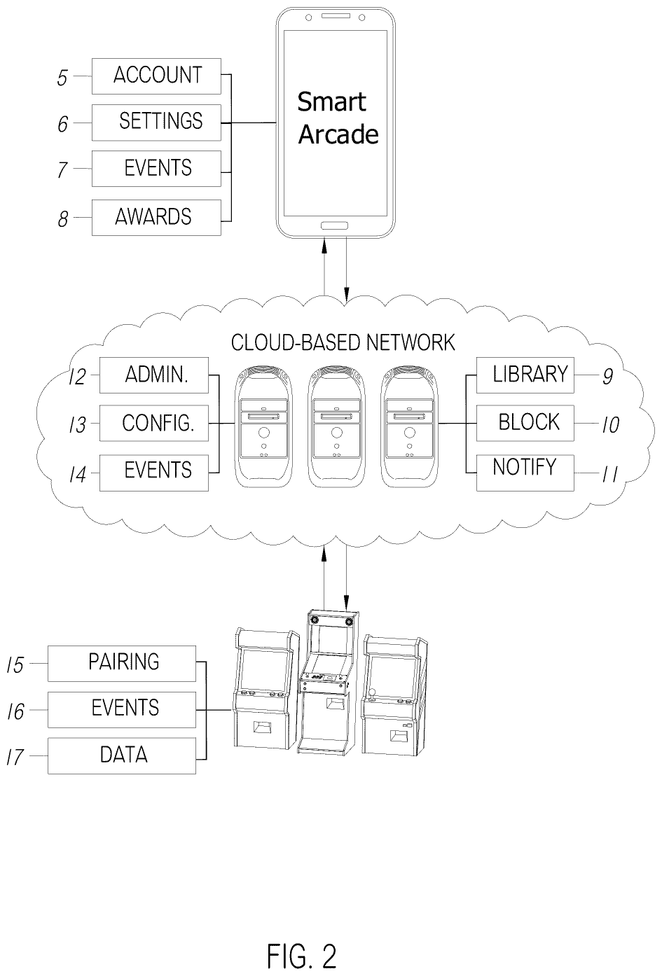

FIG. 2 shows a representative view of the invention's method wherein app 1 having operations that include but are not limited to: account information 5 (subscriptions, demographics, payments etc.); settings 6 (selecting kiosk games etc.); creating events 7 (tournaments, schedules, promotions etc.); and issuing rewards 8 (tokens, discounts etc.) being operated on a mobile device that includes but is not limited to a smart phone, tablet, laptop etc. The kiosks having operations such as but not limited to: pairing arcade machine with app 15 (local and/or wide area networks, Wi-Fi, etc.); event activities 16 (high scores, record keeping etc.); and data transmission 17 (winners, statistics, maintenance etc.). The user's mobile device and arcade machines being connected by means of cloud-based network having routines that include but are not limited to: administrative functions 12 (user data, financials, etc.); arcade machine configurations 13 (parings, machine type, etc.); event setups 14 (tournament logistics, calendars, participant lists etc.); library files 9 (encrypted event records etc.); optional block chain operations 10 (tokens, wallets, hashing etc.) and notifications 11 (email, SMS, text messages etc.).

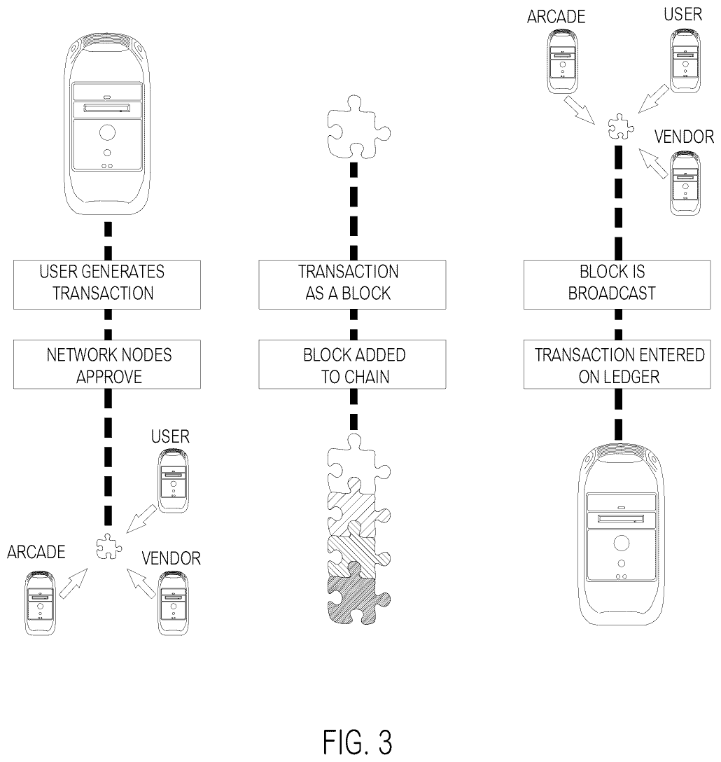

FIG. 3 shows an optional embodiment of the app having block chain software recognizes the initial transaction and it is registered as a genesis block after being approved by network nodes made up of but not limited to: operators, sponsors and players, etc. When a gamer participates in a tournament, each score is tabulated as a transaction being is encrypted and added to the previous block forming a hashed block chain wherein each transaction has a timestamp and metadata that is broadcast to said authorized stakeholders as a recorded transaction and being available only on the cloud network. By design, a block chain is resistant to modification of the data. For use as a distributed ledger, the block chain is typically managed by a peer-to-peer network, collectively adhering to a protocol for inter-node communication and validating new blocks. Once recorded, the data in any given block cannot be altered retroactively, without alteration of all subsequent blocks, which requires consensus of the network majority. Combined with smart contracts, such block chains can be considered as a decentralized notary service that allows for transparency so that anyone with preset privileges can see what is inside a data element record constructed using cryptographic hash and time stamped. Smart contracts are dynamic, live contracts that once created cannot be changed but can perform certain actions when certain conditions are met—such as sharing records automatically with pre-approved parties using digital signatures.

FIG. 4 shows the Go4Gold platform having operations that include a retailer creating a promotional campaign on the web portal (selecting promotions, choosing locations, creating offers, establishing prize fulfillment, with marketing categories and legal language); being sent to the Go4Gold cloud network; being transmitted to Go4Gold devices (monitors, kiosks, and the app); being fed to engagement analytics (whereby the sponsor is only charged per engagement); and finally appearing on the campaign dashboard having user data and options to retarget consumers with new prize promotions.

FIG. 5 shows an example of a tournament process where the consumer interacts with a network of kiosks that offer pay-to-play and free-to-play (paid by the sponsor). During pay-to-play the user makes a purchase at the kiosk with cash or card swipe and begin arcade play. They earn points as redemption tickets that are transferred to the app and are redeemed for prizes at merchants. During free-to-play users engage with the app (sign up or login) and synchronize the app with the kiosk. They select a sponsored tournament and begin the game play for promotional offers, points and prizes. They then use the app with digital vouchers to for in-store redemption (discounts and prizes etc.).

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

It is additionally noted and anticipated that although the device is shown in its most simple form, various components and aspects of the device may be differently shaped or slightly modified when forming the invention herein. As such, those ordinarily skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. A smart arcade kiosk system comprising:
a) an arcade machine configured to accept payment from players and provide gaming experiences;
b) a mobile device application (app) configured to allow players to interact with the arcade machine and participate in sponsored tournaments;
c) a web portal configured to enable sponsors to create and manage game tournaments and promotions across multiple arcade machines;
d) a cloud network connecting the arcade machines, mobile app, and web portal;
e) stakeholders including consumers, sponsors, operators, and a system manager, wherein consumers can select pay-to-play or free-to-play sponsored tournaments and compete for prizes, sponsors can create and deploy game tournaments and promotions, operators and merchants can earn a percentage of the revenue, and the system manager manages the overall operation of the system.

2. The smart arcade kiosk system of claim 1, wherein the arcade machine accepts various forms of payment including cash, coin, and credit card.

3. The smart arcade kiosk system of claim 1, wherein the web portal allows sponsors to create various types of game promotions, including fun-to-play games, esports tournaments, collect-to-win promotions, sweepstake game promotions, scavenger hunts, trivia games, fantasy sports promotions, simulation games, or other types of games.

4. The smart arcade kiosk system of claim 1, wherein players can earn loyalty points redeemable for real prizes or digital goods on any arcade machine in the network.

5. The smart arcade kiosk system of claim 1, wherein the system administrator, sponsor, or retailer can issue free game play credits or loyalty points to reward customers for specific marketing activities.

6. The smart arcade kiosk system of claim 1, wherein the arcade machine can deploy additional applications such as online stores, maps, coupon offers, video customer service, flight schedules, weather and time information, sponsor information, and other relevant applications.

7. The smart arcade kiosk system of claim 1, wherein the mobile app, email, or text notifications are used to notify customers of new promotions at retail establishments and drive customer traffic to those locations.

8. The smart arcade kiosk system of claim 1, wherein advertisers or sponsors are charged an engagement fee when consumers play for their products, and the revenue share is distributed among multiple stakeholders including the kiosk operator, retailer, game developer, and system manager.

9. The smart arcade kiosk system of claim 1, wherein advertisers can create and deploy digital advertisements on the arcade machines to generate brand awareness and attract players.

10. The smart arcade kiosk system of claim 1, wherein the web portal or app allows for remote monitoring of multiple arcade kiosks, including revenue, promotion results, and maintenance.

11. The smart arcade kiosk system of claim 1, wherein players are rewarded with loyalty points, coupons, or offers for participating in promotions, and the rewards can be stored in a mobile wallet and redeemed at retail locations or online.

12. The smart arcade kiosk system of claim 1, wherein player data is collected and analyzed using artificial intelligence to inform future promotions and target specific demographics.

13. The smart arcade kiosk system of claim 1, wherein players receive promotional messages after participating in tournaments to inform them of tournament results and upcoming events.

14. The smart arcade kiosk system of claim 1, wherein sponsors can track the return on investment of their advertising activities by monitoring player transactions and purchases related to their promotions.

15. The smart arcade kiosk system of claim 1, wherein the system establishes a revenue-sharing ecosystem among stakeholders, including advertisers, retailers, operators, and the system manager.
